(19) United States
(12) Patent Application Publication
(10) Pub. No.: US 2010/0202669 A1
(43) Pub. Date: Aug. 12, 2010

(54) IRIS RECOGNITION USING CONSISTENCY INFORMATION

(75) Inventors: Karen Hollingsworth, Notre Dame, IN (US); Kevin Bowyer, Notre Dame, IN (US); Patrick Flynn, Notre Dame, IN (US)

Correspondence Address: Schwabe Williamson & Wyatt;PACWEST CENTER, SUITE 1900, 1211 SW FIFTH AVENUE, PORTLAND, OR, 97204, US

(73) Assignee: UNIVERSITY OF NOTRE DAME DU LAC, Notre Dame, IN (US)

(21) Appl. No.: 12/679,903

(22) PCT Filed: Sep. 24, 2007
(86) PCT No.: PCT/US07/79324

§ 371 Date: Mar. 24, 2010

(51) Int. Cl. G06K 9/00

(52) U.S. Cl. 382/117

(57) ABSTRACT

Embodiments of the present invention include but are not limited to methods and systems for iris recognition. An iris recognition method may comprise comparing a plurality of images of an iris to determine at least one of one or more consistent features and one or more inconsistent features of the iris; and constructing an enrollment template for the iris based at least in part on the at least one of the one or more consistent features and the one or more inconsistent features.

### TECHNICAL FIELD

Embodiments of the invention relate generally to the field of biometrics, specifically to methods, apparatuses, and systems associated with iris recognition.

### BACKGROUND

Biometric methods have gained tremendous interest as a means for reliably verifying the identity of a person. Many current identification systems are limited to identification cards, passwords, or personal identification numbers for verifying the identity of a person, but these methods have proven to be less than desirable due to their transferability. Biometric methods, on the other hand, identify a person based on some physical or behavioral characteristic, which generally cannot be transferred or otherwise misplaced.

With regard to iris biometrics in particular, the highly-varied texture of the human iris has spurred interest in using iris recognition as a biometric means for identifying a person. Despite the advances in iris recognition systems, unfortunately, significant shortcomings exist. For example, certain areas of the iris may provide less consistent information, which may lead to unacceptable verification outcomes in terms of acceptance and rejection of identity claims. Accordingly, a more reliable system of iris recognition is of substantial importance.

### BRIEF DESCRIPTION OF THE DRAWINGS

Embodiments of the present invention will be readily understood by the following detailed description in conjunction with the accompanying drawings. Embodiments of the invention are illustrated by way of example and not by way of limitation in the figures of the accompanying drawings.

FIG. 1 schematically illustrates an image of an eye;

FIG. 2 is a flow diagram of an iris recognition enrollment method in accordance with various embodiments of the present invention;

FIG. 3 depicts exemplary inconsistent regions of iris feature vectors of five different test subjects constructed using an iris recognition enrollment method in accordance with various embodiments of the present invention;

FIG. 4 depicts exemplary inconsistent regions of an iris feature vector masked according to varying consistency thresholds using an iris recognition method in accordance with various embodiments of the present invention;

FIG. 5 is a flow diagram of an iris recognition method in accordance with various embodiments of the present invention;

FIG. 6 is a flow diagram of another iris recognition method in accordance with various embodiments of the present invention;

FIG. 7 is a block diagram of an iris recognition apparatus in accordance with various embodiments of the present invention; and

FIG. 8 is a block diagram of an article of manufacture for implementing an iris recognition method in accordance with various embodiments of the present invention.

### DETAILED DESCRIPTION OF EMBODIMENTS OF THE INVENTION

In the following detailed description, reference is made to the accompanying drawings which form a part hereof and in which is shown by way of illustration embodiments in which the invention may be practiced. It is to be understood that other embodiments may be utilized and structural or logical changes may be made without departing from the scope of the present invention. Therefore, the following detailed description is not to be taken in a limiting sense, and the scope of embodiments in accordance with the present invention is defined by the appended claims and their equivalents.

Various operations may be described as multiple discrete operations in turn, in a manner that may be helpful in understanding embodiments of the present invention; however, the order of description should not be construed to imply that these operations are order dependent.

The description may use perspective-based descriptions such as up/down, back/front, and top/bottom. Such descriptions are merely used to facilitate the discussion and are not intended to restrict the application of embodiments of the present invention.

The description may use the phrases “in an embodiment,” or “in embodiments,” which may each refer to one or more of the same or different embodiments. Furthermore, the terms “comprising,” “including,” “having,” and the like, as used with respect to embodiments of the present invention, are synonymous.

A phrase in the form of “NB” means “A or B.” A phrase in the form “A and/or B” means “(A), (B), or (A and B).” A phrase in the form “at least one of A, B and C” means “(A), (B), (C), (A and B), (A and C), (B and C) or (A, B and C).” A phrase in the form “(A) B” means “(B) or (A B),” that is, A is optional.

Various embodiments of the present invention are related to iris recognition, and methods, apparatuses, and systems for iris recognition. An article of manufacture may be adapted to perform various disclosed methods, and a computing system may be endowed with one or more components of the disclosed articles of manufacture and/or systems and may be employed to perform one or more methods as disclosed herein.

According to various embodiments, a biometric method may comprise any number of operations including, for example, one or more of characteristic acquisition (such as, for example, image acquisition), enrollment template creation, identification, and authentication. “Enrollment” generally refers to the sampling of biometric information of a system user and creation therefrom of an enrollment template. The enrollment template may be invoked or created during an authentication operation for verifying the identity of the system user. During authentication, the enrollment template may be compared to a sample to verify that the claimed identity is true. “Authentication” is sometimes alternately referred to in the art as any one or more of comparison, matching, and verification. Instead of or in addition to an authentication operation, the enrollment template may be invoked or created during an identification operation for identifying an unknown person. During identification, a sample may be acquired from the unknown person and matched against one or more enrolled persons to identify the unknown person.

With respect to biometric methods using the human iris as the biometric trait, it has been observed that some textural features of a human iris, or some representation of the textural features, may not necessarily be consistent. In general, “inconsistency” may refer to a particular feature, or representation/indication of a feature, having some probability of differing between images of the same iris. Inconsistency may be a result of specific physical features of the iris, or may be developed during an acquisition or enrollment template creation operation. For example, when an image of the eye is taken, the resulting image may be a discretized image of an original consistent signal. If the physical eye is moved one-half pixel, for instance, in one direction, the resulting discretized image may be different. Inconsistencies may also arise if the head is tilted at different angles at different times. Still further, a segmentation algorithm (i.e., one that finds the iris and pupil in the image) may misestimate the location of the iris and/or the pupil, which may result in an inconsistency.

In any event, failure to account for such inconsistencies may have the result of unacceptable verification outcomes in terms of acceptance and rejection of identity claims. For example, a false acceptance or false rejection of an identity claim may occur. In identification schemes, failure to account for inconsistencies may result in unacceptable identification outcomes in terms of misidentification or non-identification.

For various embodiments of the present invention, an iris recognition method may comprise acquiring a plurality of images of an iris, comparing the plurality of images to determine one or more consistent features and one or more inconsistent features of the iris, and constructing an enrollment template for the iris based at least in part on the one or more consistent features and the one or more inconsistent features.

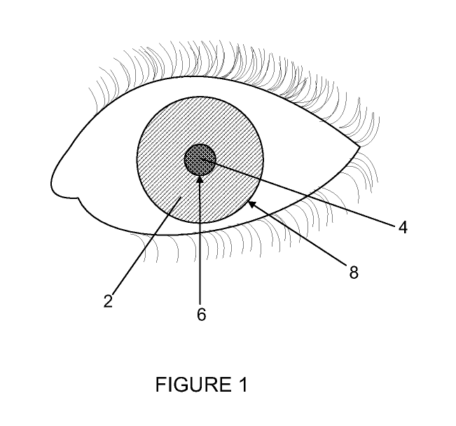

Some generally-known features of an eye are discussed herein. For reference, these features are also illustrated in FIG. 1. As illustrated, an eye generally includes, but is not limited to, an iris 2, a pupil 4, a pupillary boundary 6, and a limbic boundary 8.

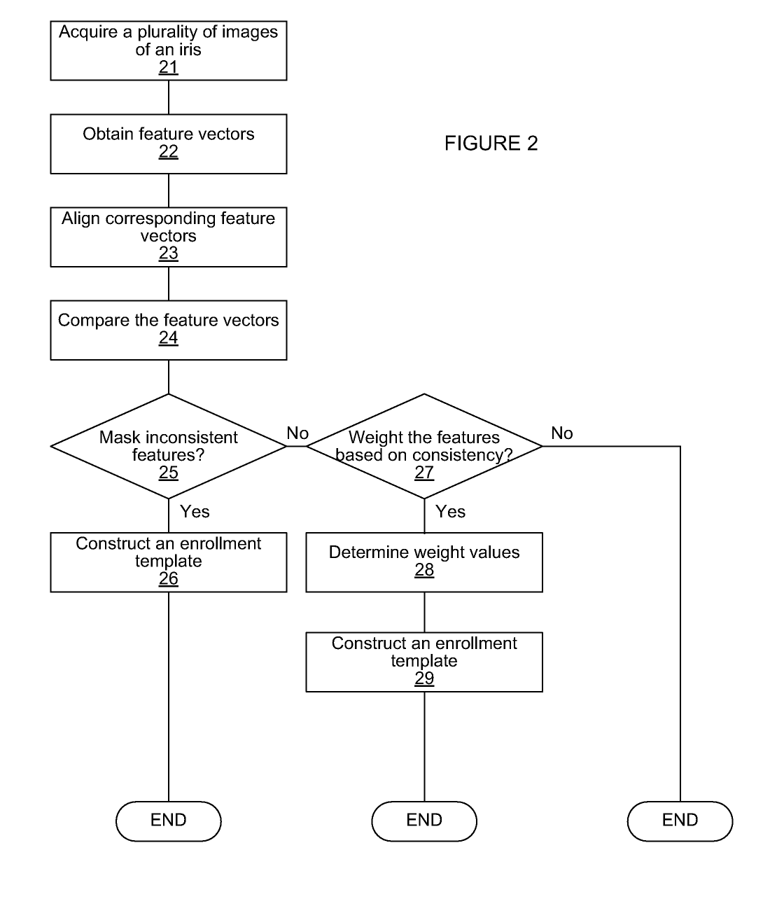

Turning now to FIG. 2, illustrated is a flow diagram of a portion of the operations associated with constructing an enrollment template, which may be invoked during an authentication operation for verifying the identity of a subject.

An iris image may be acquired at block 21 according to any method suitable for the purpose. For example, an image may be acquired using a conventional camera. In some embodiments, a suitable sensor may be employed. In still further embodiments, images may be acquired from a video stream. In embodiments, an image may be obtained of an eye, and the iris region of the image of the eye may be extracted or segmented therefrom.

In various embodiments, an iris image may be acquired using light at a suitable wavelength or wavelength range. For example, a wavelength range of 700-900 nanometer (nm) (near-infrared illumination) may be suitable. The acquisition system may also vary in its obtrusiveness to the subject. In various embodiments, for example, a subject may be prompted to position the eye at a certain spatial orientation for focusing and/or for obtaining an iris image of a certain size. In other embodiments, however, an acquisition system may be of a less obtrusive nature, actively locating and acquiring an image of any eye in a certain spatial relation to the camera (or other acquisition device).

After acquiring one or more images of a subject's eye, the iris region of the eye images may be segmented for analysis. Segmentation refers to locating that part of the acquired image that corresponds to the iris region. Locating the iris may be based upon assumptions regarding the general shape and/or location of the eye/iris relative to other features of the face/eye. According to various embodiments, the pupillary and limbic boundaries may be approximated as circles such that a boundary may be described in terms of radius, r, and circle coordinates, x₀ and y₀. An integro-differential operator may be used for detecting the iris boundary by searching the parameter space. An exemplary integro-differential operator is:

$$max ( r , {x}_{0} , {y}_{0} ) \vert Gσ ( r ) * \frac{\partial }{\partial r} {∮}_{r , {x}_{0} , {y}_{0}} \frac{1 ( x , y )}{2 π r} d s \vert$$

where Gσ(r) is a smoothing function and I(x,y) is the image of the eye. It is important to note that the disclosed invention is not limited to the foregoing segmentation method. Any number of various other segmentation methods may be similarly suitable.

It is known that the pupillary and limbic boundaries are not always perfectly circular. Furthermore, noise may be introduced by way of occlusion by eyelids, eyelashes, and/or specularities. Accordingly, alternative segmentation methods may be employed to better model the iris boundaries.

Once the iris has been located, the iris texture may be analyzed at block 22 to obtain one or more feature vectors. Iris texture may be analyzed and represented according to one or more of various approaches. In various embodiments, the binary feature vector method may be used to extract the textural features of the iris(es), which includes obtaining a normalized iris image to account for differences in iris sizes across subjects, and displaying the normalized image, for example, in rectangular form, with a radial coordinate (a value between 0 and 1) on the vertical axis, and an angular coordinate (a value between 0 and 360 degrees) on the horizontal axis. Accordingly, the pupillary boundary of the iris is along the bottom of the normalized image, and the limbic boundary is along the top. Further, the left side of the normalized image marks 0 degrees on the iris image, and the right side marks 360 degrees.

In an embodiment, using convolution with 2-dimensional Gabor filters allows for extraction of the texture from the normalized image. Complex coefficients are generated by multiplying the filters by the pixel data of the raw image. In an embodiment, the values representing the complex coefficients may then be binarized. In an embodiment, the complex coefficients may be transformed into a two-bit code, the first bit representing the real part of the coefficient and the second bit representing the imaginary part of the coefficient. In an alternate embodiment, only part of the complex coefficients may be binarized, or only one bit may be generated from the complex value. In an embodiment, after analyzing the image using the Gabor filters, the information from the iris images may be summarized, for example, in a 256 byte (2048 bit) binary code, which may be compared efficiently using bitwise operations during an authentication operation (i.e., matching of the enrollment template with the sample image).

Other methods may be similarly suitable for analyzing and representing the iris texture. For example, another method for binary representation may be used instead of the method discussed above. Alternatively, the iris texture may be represented by using a real-valued feature vector. In still other embodiments, some combination of binary and real-valued feature vectors may be employed. In still further embodiments, a complex-valued feature vector may be used, or some other representation that represents the iris texture in a manner allowing for a determination of consistency (as discussed more fully herein) across different representations.

Alignment of feature vectors may be performed at block 23 in situations in which multiple images of an eye have differences in orientation. Unsurprisingly, multiple images of an eye may not necessarily have the same orientation due, for example, to small movements of the eye (or of the body) that tend to occur even over small intervals of time. Specifically, if a head is tilted in one image and upright in a second image, the feature vector extracted from the first image may be a shifted version of the feature vector extracted from the second image. Accordingly, in an embodiment, feature vectors may be aligned so that all feature vectors correspond to the same orientation of the subject iris.

In various embodiments, feature vectors may be aligned by taking a first acquired image as a reference. Feature vectors of other acquired images may then be compared to the feature vector of the first acquired image (first feature vector) at multiple possible shifts. For each shift, a distance measure may be computed between the first feature vector and a particular other feature vector (second feature vector). The shift corresponding to the smallest possible distance may be taken to be to the correct orientation for the second feature vector.

In some embodiments, the second feature vector may be aligned to the first feature vector, and a third feature vector of yet another acquired image may be compared to the first and the second feature vectors. In determining the correct orientation for the third vector, the third vector may be compared to both the first and the second previously-aligned vectors. Other feature vectors may be compared to some or all of previous feature vectors in determining the optimal shift. It is noted that as used here, “first,” “second,” and “third” do not necessarily refer to first, second, or third in a sequence. The first, second, or third acquired images may, for example, be any one of a series of acquired images chosen, selectively or at random, for alignment.

As noted herein, in various embodiments multiple images may be acquired from a video stream. In the embodiments, information from the video stream may be used for aligning feature vectors.

Other suitable alignment methods may be employed for aligning feature vectors or iris images. In some embodiments, alignment may be excluded altogether as desired.

Given multiple feature vectors, which may or may not be aligned, the feature vectors may be compared and analyzed for consistency at block 24. For embodiments in which feature vectors are represented in binary form, an average of each bit in the feature vector may be determined. If the average for a given bit is within a predetermined distance (a threshold) to either 0 or 1, then the bit may be considered consistent. The maximum inconsistency, then, would be 0.5, the mid-point between 0 and 1.

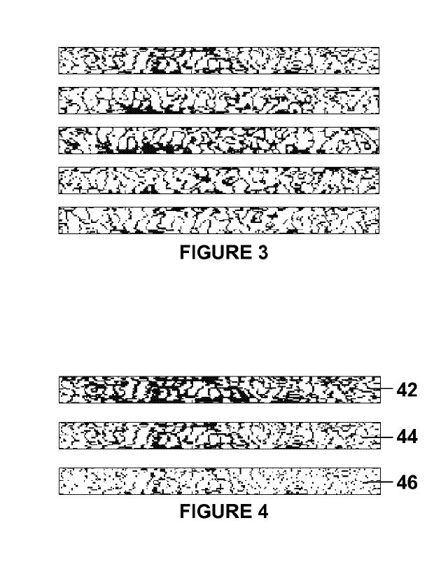

FIG. 3 illustrates exemplary inconsistent regions of iris feature vectors of five different test subjects. For each of the test subjects, a plurality of images were acquired of the subject's iris, and a binary feature vector was obtained for each image, resulting in a plurality of binary feature vectors for each subject's iris. The plurality of binary feature vectors were aligned and compared. In the illustrated feature vectors, the black regions correspond to inconsistent regions, based on a threshold inconsistency value of 30%. In this embodiment, the 30% value refers to both a bit from the feature vector being equal to 1 for some of the images but 0 for at least 30% of the images, and a bit from the feature vector being equal to 0 for some of the images but 1 for at least 30% of the images. Here, the 30% threshold is merely exemplary, and so, in various other embodiments, inconsistency may be defined at some value more or less than 30%.

Although a binary feature vector system may permit fast comparisons between feature vectors, other non-binary feature vectors may be employed within the scope of embodiments of the present invention. In some of these embodiments, an average and a standard deviation of each element of the feature vector may be determined. Elements with a high standard deviation (or a standard deviation outside of an acceptability window) may be deemed inconsistent. In still further embodiments, other measures of inconsistency may be employed.

Having made a determination of the consistency or inconsistency of one or more bits of a feature vector, the consistent and/or inconsistent bits may be variously treated in generating an enrollment template. For example, in various embodiments and as depicted at query block 25 of FIG. 2, inconsistent bits may be masked or otherwise ignored when constructing an enrollment template at block 26 so that decisions regarding the identity of a subject may be based solely on the most consistent parts of the iris feature vector. In various ones of these embodiments, a threshold value, τ, may be defined, where 0<τ<0.5. If, for example, τ is set to 0.4, any bit with an average value greater than τ and less than 1−τ is masked with a consistency mask (i.e., values between 0.4 and 0.6 are masked). Needless to say, varying the threshold value may affect the amount of information masked as evident in FIG. 4. For the feature vector depicted in FIG. 4, black regions correspond to inconsistent bits as defined by a predetermined threshold value. At 42, the feature vector was masked by a threshold value of τ=0.2; at 44, by a threshold value of τ=0.3; and at 46, by a threshold value of τ=0.4. As illustrated, as the threshold value increases, so too does the number of bits masked. Accordingly, in an embodiment, an appropriate level of optimization may be desired, depending on the application.

In various embodiments, a threshold value, τ, may be predetermined and kept constant for a plurality of subjects. In various other embodiments, however, the threshold value may be varied for each subject. For example, the threshold value may be set for each subject so that a certain percentage of the feature vector remains unmasked by the consistency mask. This embodiment may be desirable to retain a minimum amount of information for subsequent comparison.

In alternate embodiments, rather than masking inconsistent features, it may be preferred to weight features based on their consistency at block 27 of FIG. 2. In various ones of these embodiments, parts of an iris feature vector may be weighted as depicted at block 28 and used for constructing an enrollment template at block 29 so that more consistent parts of the feature vector are given more weight in comparisons (authentication) relative to less consistent parts of the feature vector.

In embodiments, one or more other masks in addition to a consistency mask and/or weighting may be included in an enrollment template for a subject. For example, in various embodiments, an occlusion mask may be included in an enrollment template to account for occlusion by eyelids, eyelashes, and/or specularities.

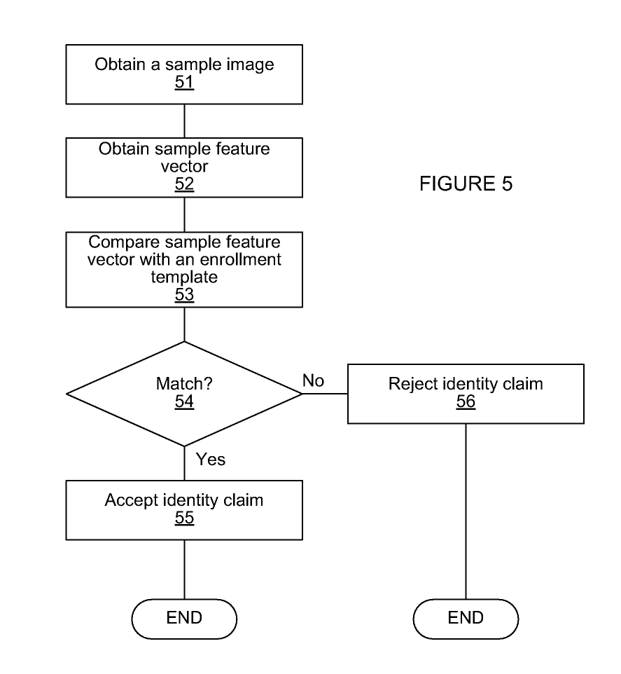

Turning now to FIG. 5, illustrated is a flow diagram of a portion of the operations associated with authentication operations for verifying the identity of a subject. An enrollment template, including any masking and/or weighting, may be used for verifying the identity of a subject. In various embodiments, the enrollment template may be one constructed according to the method described with reference to FIG. 2. In general, during authentication, the enrollment template is compared to a sample feature vector, the sample feature vector acquired for a subject purporting to have the identity corresponding to the enrollment template. The enrollment template may be one created prior to or during one or more authentication operations, depending on the application.

A sample iris image may be obtained at block 51 of FIG. 5 according to any method suitable for the purpose and may be a method similar to one described with reference to enrollment template generation, described herein. For example, an image may be one acquired using a conventional camera. In some embodiments, a suitable sensor may be employed. In still further embodiments, images may be acquired from a video stream. In various embodiments, the sample iris image may be one that has already been acquired, the sample iris image being in a form substantially ready for use in one or more authentication operations including, for example, analysis of the sample iris image for consistent/inconsistent features and/or comparison to another image (e.g., an enrolled image).

A sample feature vector may be obtained for the sample iris at block 52. The sample feature vector may be obtained using any method suitable for the purpose and may be a method similar to one described with reference to enrollment template generation, described herein. For example, a sample feature vector may be a binary feature vector. Alternatively, a sample feature vector may be a real-valued feature vector. In still other embodiments, some combination of binary and real-valued feature vectors may be employed. In still further embodiments, a complex-valued feature vector may be used, or some other representation that represents the sample iris texture in a manner allowing for a determination of consistency (as discussed more fully herein) across different representations.

An enrollment template may be compared to a sample feature vector at block 53 to determine whether the enrollment template and the sample match at query block 54. In various embodiments, a comparison may be made between a sample feature vector and an enrolled feature vector of the enrollment template. Any suitable method may be used for the comparing. For example, in various embodiments, the bits of binary feature vectors may be compared according to the normalized Hamming distance. The normalized Hamming distance generally refers to the fraction of bits that differ between binary feature vectors (i.e., the bits that disagree).

According to various embodiments, the Boolean logic representation for finding the bits that differ between two binary feature vectors may be the exclusive OR (⊕) function. Accordingly, bits in a feature vector that are unoccluded (if an occlusion mask is included in the enrollment feature vector) and consistent (if a consistency mask is included in the enrollment feature vector) may be represented by a logic 1 in the occlusion mask and consistency mask, respectively. An intersection operation (∩) may be used to find the bits that are unoccluded (if an occlusion mask is included in the enrollment feature vector) and consistent (if a consistency mask is included in the enrollment feature vector) in both the enrolled feature vector and the sample feature vector. Accordingly, the fraction of consistent, unoccluded bits that disagree between the enrolled feature vector and the sample feature vector may be determined according to the following algorithm:

$$\frac{\vert \vert ( F {V}_{A} ⊕ F {V}_{B} ) ⋂ O {M}_{A} ⋂ O {M}_{B} ⋂ C {M}_{A} \vert \vert}{\vert \vert {OM}_{A} ⋂ {OM}_{B} ⋂ {CM}_{A} \vert \vert}$$

where FV_{A} refers to the enrolled feature vector; FV_{B} refers to the sample feature vector; OM_{A} refers to the occlusion mask for the enrolled feature vector; CM_{A} refers to the consistency mask for the enrolled feature vector; and OM_{B} refers to the occlusion mask for the sample feature vector.

Notice in the foregoing embodiment that the sample feature vector includes an occlusion mask. Such a mask may be included, in various embodiments, during the comparison operation to account for occlusion by eyelids, eyelashes, and/or specularities of the sample taken from the subject purporting to have the identity corresponding to the enrollment template.

Rather than separating the consistency mask and the occlusion mask as was done in the foregoing embodiment, the masks may be combined into one vector in various embodiments. Combining the masks into one vector may reduce storage volume of enrollment data and/or processing time for the authentication.

As noted previously, parts of an iris feature vector may be weighted so that the more consistent parts of the feature vector are given more weight relative to less consistent parts of the feature vector. In various embodiments in which binary feature vectors are used, the average value for each bit may be stored in an array, Avg. If a bit is less than 0.5, then the consistency weights vector, CW, for that bit may be computed to be 2*(0.5−(average value for bit)). Otherwise, if the bit is greater than or equal to 0.5, CWfor that bit may be computed to be 2*((average value for bit)−0.5). This algorithm may be an iterative function represented as:

for i=1 to |Avg|

if Avg[i] < 0.5

then CW[i] = 2*(0.5−Avg[i])

else

CW[i] = 2*(Avg[i] −0.5)

end

In this embodiment, the distance between the enrollment feature vector and the sample feature vector may be determined according to the following algorithm:

$$\frac{{\sum }_{i} ( F {V}_{A} ⊕ F {V}_{B} ) [ i ] \cdot ( O {M}_{A} ⋂ O {M}_{B} ) [ i ] \cdot CW [ i ]}{{\sum }_{i} ( O {M}_{A} ⋂ O {M}_{B} ) [ i ] \cdot CW [ i ]}$$

Other methods may be employed for an authentication operation in addition to or alternately to the foregoing methods. For example, in some embodiments, consistency information may be calculated from images or feature vectors from a sample subject rather than an enrolled subject. In other embodiments, consistency information may be calculated from images or feature vectors from both the sample subject and enrolled subject.

According to various embodiments, if the enrolled feature vector and the sample feature vector match, an indication of identity acceptance may be provided at block 55. Otherwise, an indication of identity rejection may be provided at block 56 if the enrolled feature vector and the sample feature vector do not match. In determining whether feature vectors match, any criteria suitable for the purpose may be employed. For example, a determination of a match may be made if a predetermined percentage (e.g., 70%, or some other percentage) of bits of binary feature vectors match. In embodiments, the determination of identity rejection may prompt one or more resulting actions, such as requiring a further proffer of identity (such as other biometric indicia including fingerprints, voice, etc., or other form of identification), or providing notification or alarm to an individual or to a device.

As noted previously, a biometric method may sometimes comprise one or more identification operations for identifying an unknown subject. During identification, a sample may be acquired from the unknown subject and matched against one or more enrolled subjects to identify the unknown subject.

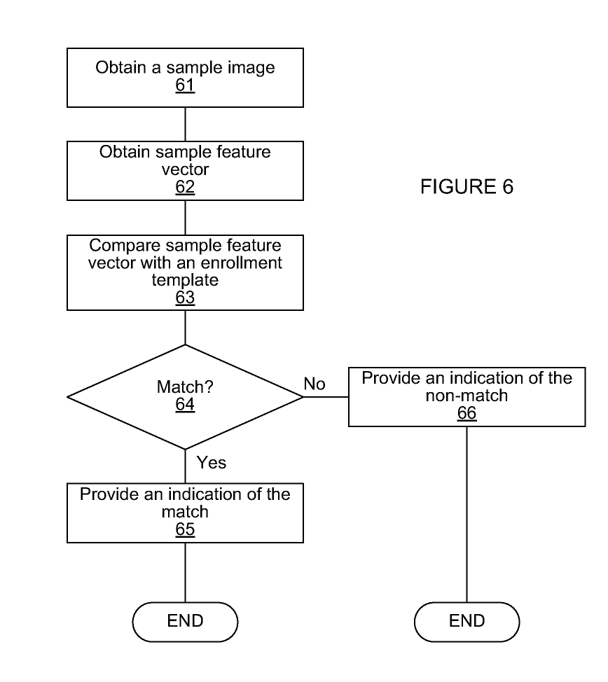

Illustrated in FIG. 6 is a portion of the operations associated with an exemplary identification method. An enrollment template, including any masking and/or weighting, may be used for identifying an unknown subject. In various embodiments, the enrollment template may be one constructed according to the method described with reference to FIG. 2. In general, during identification, a sample from the unknown subject may be compared against one or more enrolled subjects. The enrollment template may be one created prior to or during one or more identification operations, depending on the application.

A sample iris image may be obtained at block 61 of FIG. 6 according to any method suitable for the purpose and may be a method similar to one described with reference to enrollment template generation such as described herein. For example, an image may be one acquired using a conventional camera. In some embodiments, a suitable sensor may be employed. In still further embodiments, images may be acquired from a video stream. In various embodiments, the sample iris image may be one that has already been acquired, the sample iris image being in a form substantially ready for use in one or more identification operations including, for example, analysis of the sample iris image for consistent/inconsistent features and/or comparison to another image (e.g., an enrolled image).

A sample feature vector may be obtained for the sample iris at block 62. The sample feature vector may be obtained using any method suitable for the purpose and may be a method similar to one described with reference to enrollment template generation described herein. For example, a sample feature vector may be a binary feature vector. Alternatively, a sample feature vector may be a real-valued feature vector. In still other embodiments, some combination of binary and real-valued feature vectors may be employed. In still further embodiments, a complex-valued feature vector may be used, or some other representation that represents the sample iris texture in a manner allowing for a determination of consistency (as discussed more fully herein) across different representations.

An enrollment template may be compared to a sample feature vector at block 63 to determine whether the enrollment template and the sample match at query block 64. In various embodiments, a comparison may be made between a sample feature vector and an enrolled feature vector of the enrollment template. Any suitable method may be used for the comparing. For example, in various embodiments, the bits of binary feature vectors may be compared according to the normalized Hamming distance, described herein. Comparison between the sample feature vector and the enrollment template may include any one or more of various comparison operations as described above with reference to authentication, with or without the various masks.

Other methods may be employed for an identification operation in addition to or alternately to the foregoing methods. For example, in some embodiments, consistency information may be calculated from images or feature vectors from a sample subject rather than an enrolled subject. In other embodiments, consistency information may be calculated from images or feature vectors from both the sample subject and enrolled subject.

According to various embodiments, if the enrolled feature vector and the sample feature vector match, an indication of the match may be provided at block 65. Otherwise, an indication of a non-match may be provided at block 66 if the enrolled feature vector and the sample feature vector do not match. In determining whether feature vectors match, any criteria suitable for the purpose may be employed. For example, a determination of a match may be made if a predetermined percentage (e.g., 70%, or some other percentage) of bits of binary feature vectors match. In embodiments, the determination of a non-match may prompt one or more resulting actions, such as requiring a further proffer of identity (such as other biometric indicia including fingerprints, voice, etc., or other form of identification), or providing notification or alarm to an individual or to a device.

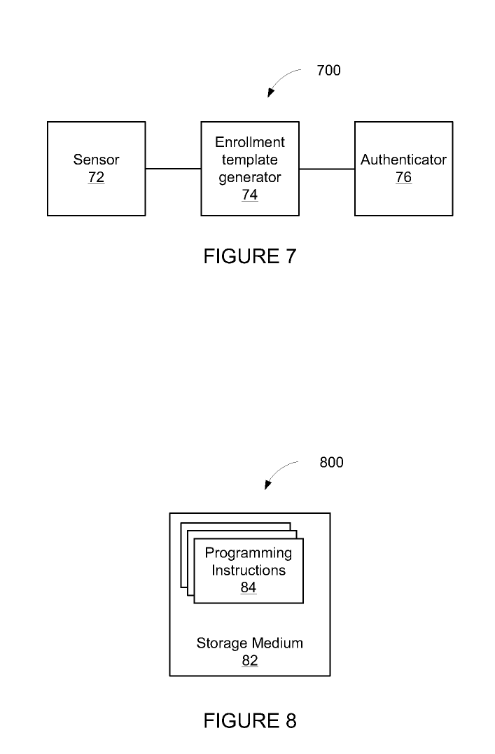

Turning now to FIG. 7, an iris recognition apparatus 700 may be configured to perform any one or more of various embodiments, in part or in whole, as discussed herein. In the illustrated embodiment, iris recognition apparatus 700 may comprise a sensor 72, an enrollment template generator 74, and an authenticator 66.

Sensor 72 may be configured to acquire a plurality of images. According to various embodiments, sensor 72 may be configured to acquire images during an enrollment operation and/or during an authentication operation. Sensor 72 may be a camera or similar device. In some embodiments, sensor 72 may be configured to capture one or more of still and moving images, depending on the application.

Enrollment template generator 74 may be configured to perform one or more enrollment operations as described herein. For example, in various embodiments, enrollment template generator 74 may be configured to align a plurality of images to an orientation of an iris. In various embodiments, enrollment template generator 74 may be configured to compare a plurality of images to determine one or more consistent features and one or more inconsistent features of an enrolled iris. In still further embodiments, enrollment template generator 74 may be configured to construct an enrollment template for an enrolled iris based at least in part on the one or more consistent features and the one or more inconsistent features. The constructed enrollment template may, in embodiments, include one or more masks and/or one or more weight values.

Authenticator 76 may be configured to perform one or more authentication operations as described herein. For example, authenticator 76 may be configured to compare a sample image with an enrollment template to determine whether the sample iris and the enrolled iris match.

Iris recognition apparatus 700 may be further adapted to store various information associated with iris recognition. For instance, iris recognition apparatus 700 may be adapted to store one or more of parameters, instructions, and enrollment templates for performing one or more methods as disclosed herein.

Any one or more of various embodiments as previously discussed may be incorporated, in part or in whole, into an article of manufacture. In various embodiments and as shown in FIG. 8, an article of manufacture 800 in accordance with various embodiments of the present invention may comprise a storage medium 82 and a plurality of programming instructions 82 stored in storage medium 82. In various ones of these embodiments, programming instructions 84 may be adapted to program an apparatus to enable the apparatus to perform one or more of the previously-discussed methods. For example, programming instructions 84 may be adapted to program an apparatus to enable the apparatus to perform enrollment and/or authentication operations as described herein.

Although certain embodiments have been illustrated and described herein for purposes of description of the preferred embodiment, it will be appreciated by those of ordinary skill in the art that a wide variety of alternate and/or equivalent embodiments or implementations calculated to achieve the same purposes may be substituted for the embodiments shown and described without departing from the scope of the present invention. Those with skill in the art will readily appreciate that embodiments in accordance with the present invention may be implemented in a very wide variety of ways. This application is intended to cover any adaptations or variations of the embodiments discussed herein. Therefore, it is manifestly intended that embodiments in accordance with the present invention be limited only by the claims and the equivalents thereof.

1. An iris recognition method comprising:
comparing a plurality of images of an iris; and
determining at least one of one or more consistent features and one or more inconsistent features of the iris.

2. The method of claim 1, further comprising forming a feature vector for each of the plurality of images, and wherein said comparing comprises comparing the feature vectors to determine the at least one of the one or more consistent features and the one or more inconsistent features of the iris.

3. The method of claim 2, wherein said forming the feature vector comprises forming a binary feature vector for each of the plurality of images.

4. The method of claim 2, wherein said forming the feature vector comprises forming a real-valued or complex-valued feature vector for each of the plurality of images.

5. The method of claim 2, further comprising aligning the feature vectors to an orientation of the iris.

6. The method of claim 1, wherein said comparing comprises identifying the at least one of the one or more consistent features and the one or more inconsistent features based at least in part on a consistency threshold.

7. The method of claim 1, further comprising constructing an enrollment template for the iris based at least in part on said comparing.

8. The method of claim 7, wherein the enrollment template includes at least one of a consistency mask to mask the one or more inconsistent features and an occlusion mask to mask one or more occlusions of the iris.

9. The method of claim 7, wherein said constructing the enrollment template comprises assigning a weight value for each of the at least one of the one or more consistent features and the one or more inconsistent features based at least in part on a consistency value corresponding to each of the features.

10. An iris recognition method comprising:
obtaining an enrollment template corresponding to an enrolled iris, the enrollment template including information based at least in part on at least one of one or more consistent features and one or more inconsistent features of the enrolled iris; and
comparing at least one sample image of a sample iris with the enrollment template to determine whether the sample iris and the enrolled iris match.

11. The method of claim 10, wherein said obtaining the enrollment template comprises:
comparing a plurality of images of an iris to be enrolled to determine at least one of one or more consistent features and one or more inconsistent features of the iris; and
constructing the enrollment template for the enrolled iris based at least in part on said comparing the plurality of images of the enrolled iris.

12. The method of claim 11, further comprising obtaining the at least one sample image, and wherein said obtaining the enrollment template is performed during or after said obtaining the at least one sample image.

13. The method of claim 10, further comprising:
comparing a plurality of sample images of the sample iris to determine at least one of one or more consistent features and one or more inconsistent features of the sample iris; and
wherein said comparing the at least one sample image of the sample iris comprises comparing the enrollment template with information based at least in part on the at least one of one or more consistent features and the one or more inconsistent features of the sample iris.

14. The method of claim 10, further comprising providing an indication of identity acceptance of the sample iris if it is determined that the sample iris and the enrolled iris match.

15. The method of claim 10, further comprising providing an indication of a match it is determined that the sample iris and the enrolled iris match.

16. The method of claim 10, further comprising forming a sample feature vector for the sample image, and wherein said comparing comprises comparing the sample feature vector with the enrollment template to determine whether the sample iris and the enrolled iris match.

17. The method of claim 10, further comprising masking one or more occlusions of the sample iris.

18. The method of claim 10, wherein the enrollment template is configured to mask the one or more inconsistent features of the enrolled iris.

19. The method of claim 10, wherein the enrollment template includes a weight value for each of the one or more consistent features and one or more inconsistent features based at least in part on a consistency value corresponding to each of the features.

20. An iris recognition apparatus comprising:
a sensor configured to acquire a plurality of images of an iris; and
an enrollment template generator configured to compare the plurality of images to determine one or more consistent features and one or more inconsistent features of the iris, and to construct an enrollment template for the iris based at least in part on the one or more consistent features and the one or more inconsistent features, wherein the iris for which an enrollment template has been constructed is termed an enrolled iris.

21. The apparatus of claim 20, wherein the sensor is further configured to acquire a sample image of a sample iris.

22. The apparatus of claim 21, further comprising an authenticator configured to compare the sample image with the enrollment template to determine whether the sample iris and the enrolled iris match.

23. The apparatus of claim 20, wherein the enrollment template generator is further configured to align the plurality of images to an orientation of the iris.

24. The apparatus of claim 20, wherein the enrollment template is configured to mask the one or more inconsistent features.

25. The apparatus of claim 20, wherein the enrollment template generator is further configured to assign a weight value for each of the one or more consistent features and one or more inconsistent features based at least in part on a consistency value corresponding to each of the features.
